(19) United States
(12) Patent Application Publication
(10) Pub. No.: US 2026/0196888 A1
(43) Pub. Date: Jul. 9, 2026

(54) ROTATING ELECTRIC MACHINE AND DRIVE DEVICE

(71) Applicant: NIDEC CORPORATION, Kyoto (JP)

(72) Inventors: Kosuke MIZUIKE, Kyoto (JP); Kazutoshi MATSUDA, Kyoto (JP)

(21) Appl. No.: 19/551,604

(22) Filed: Feb. 27, 2026

Related U.S. Application Data
(63) Continuation of application No. PCT/JP2024/029472, filed on Aug. 20, 2024.

(30) Foreign Application Priority Data
Aug. 31, 2023 (JP) 2023-141793

(51) Int. Cl. H02K 1/20; H02K 1/14; H02K 7/116

(52) U.S. Cl. CPC H02K 1/20; H02K 1/145; H02K 7/116

(57) ABSTRACT

The present disclosure includes a rotor that is rotatable about a central axis, a stator that includes a stator core facing the rotor in a radial direction with a gap therebetween, and a guide member that is disposed on one side of the stator core in the axial direction and supplies a refrigerant in a circumferential direction. The stator core is provided with a plurality of stator flow paths that penetrate the stator core in an axial direction and through which the refrigerant flows. The plurality of stator flow paths are disposed at different positions in the circumferential direction. The guide member includes a connection flow path portion that connects the plurality of stator flow paths, and is configured with a plurality of flow path members stacked in the axial direction.

### CROSS-REFERENCE TO RELATED APPLICATIONS

This application is a continuation of International Application No. PCT/JP2024/029472, filed on Aug. 20, 2024, which claims priority to Japanese Patent Application No. 2023-141793, filed on Aug. 31, 2023, the entire contents of which are incorporated herein by reference.

### TECHNICAL FIELD

The present disclosure relates to a rotating electric machine and a drive device.

### BACKGROUND

A rotating electric machine that cools a stator core by disposing, above a stator, a cooling oil supply pipe with injection holes for injecting cooling oil, and supplying cooling oil injected from the injection holes to the stator has become known.

In the above-described rotating electric machine, for example, the amount of cooling oil supplied to the stator tends to vary circumferentially, which can easily cause temperature unevenness of the stator. For this reason, there is a concern that the temperature of a portion of the stator may become excessively high.

### SUMMARY

One aspect of a rotating electric machine of the present disclosure includes a rotor that is rotatable about a central axis, a stator that includes a stator core facing the rotor in a radial direction with a gap therebetween, and a guide member that is disposed on one side of the stator core in the axial direction and supplies a refrigerant in a circumferential direction. The stator core is provided with a plurality of stator flow paths that penetrate the stator core in an axial direction and through which the refrigerant flows. The plurality of stator flow paths are disposed at different positions in the circumferential direction. The guide member includes a connection flow path portion that connects the plurality of stator flow paths, and is configured with a plurality of flow path members stacked in the axial direction.

One aspect of a drive device of the present disclosure includes the rotating electric machine described above and a gear mechanism that is connected to the rotor.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a schematic diagram illustrating a drive device of a first preferred embodiment;

FIG. 2 is a cross-sectional view illustrating a rotating electric machine of the first preferred embodiment;

FIG. 3 is a perspective view illustrating a guide member and a supply flow path portion of the first preferred embodiment;

FIG. 4 is a cross-sectional view illustrating a portion of a rotating electric machine of the first preferred embodiment;

FIG. 5 is a partially enlarged cross-sectional view illustrating a portion of the rotating electric machine of the first preferred embodiment;

FIG. 6 is an external view of the guide member of the first embodiment, when viewed from one side in an axial direction;

FIG. 7 is an exploded perspective view illustrating the guide member of the first preferred embodiment;

FIG. 8 is a second external view of the guide member of the first preferred embodiment, when viewed from one side in an axial direction;

FIG. 9 is a cross-sectional view illustrating a portion of the rotating electric machine of the first preferred embodiment, taken along line IX-IX in FIG. 6;

FIG. 10 is an exploded perspective view illustrating a guide member of a second preferred embodiment;

FIG. 11 is a cross-sectional view illustrating a portion of a rotating electric machine according to the second preferred embodiment;

FIG. 12 is an exploded perspective view illustrating a guide member according to a third preferred embodiment;

FIG. 13 is a cross-sectional view illustrating a portion of a rotating electric machine according to the third preferred embodiment;

FIG. 14 is a cross-sectional view illustrating a rotating electric machine according to a fourth preferred embodiment; and

FIG. 15 is an exploded perspective view illustrating a guide member according to the fourth preferred embodiment.

### DETAILED DESCRIPTION

In the following description, a vertical direction is defined based on a positional relationship when a drive device of an embodiment is mounted on a vehicle positioned on a horizontal road surface. That is, a positional relationship with respect to the vertical direction described in the following embodiments only needs to be satisfied when the drive device is mounted on the vehicle positioned on the horizontal road surface.

In each drawing, an XYZ coordinate system is shown as a three-dimensional orthogonal coordinate system as appropriate. In the XYZ coordinate system, a Z-axis direction is the vertical direction. A +Z side is an upper side in the vertical direction, and a −Z side is a lower side in the vertical direction. In the following description, the upper side in the vertical direction will simply be referred to as an “upper side,” and the lower side in the vertical direction will simply be referred to as a “lower side.” An X-axis direction is orthogonal to the Z-axis direction and corresponds to a front-back direction of the vehicle on which the drive device is mounted. In the following embodiments, a +X side is the front side of the vehicle, and a −X side is the rear side of the vehicle. A Y-axis direction is a direction orthogonal to both the X-axis and Z-axis directions and corresponds to the left-right direction of the vehicle, that is, the vehicle width direction. In the following embodiments, a +Y side is the right side of the vehicle, and a −Y side is the left side of the vehicle.

A positional relationship in the front-back direction is not limited to the positional relationship in the following embodiments, the +X side may be the rear side of the vehicle and the −X side may be the front side of the vehicle. In this case, the +Y side is the left side of the vehicle, and the −Y side is the right side of the vehicle. In this specification, a “parallel direction” includes a substantially parallel direction, and an “orthogonal direction” includes a substantially orthogonal direction.

A central axis J shown in each drawing is a virtual axis extending in the Y-axis direction, that is, the left-right direction of the vehicle. In the present embodiment, the central axis J extends in a direction orthogonal to the vertical direction (Z-axis direction). That is, the central axis J extends in a direction intersecting the vertical direction. In the following description, the direction parallel to the central axis J will be referred to simply as an “axial direction”, the radial direction centered on the central axis J will be referred to simply as a “radial direction”, and the circumferential direction centered on the central axis J will be referred to simply as a “circumferential direction”. The +Y side is referred to as “one side in the axial direction” and the −Y side is referred to as “the other side in the axial direction”.

The circumferential direction is indicated by an arrow θ in each diagram. A side (+0 side) in the circumferential direction which faces the arrow θ is referred to as “one side in the circumferential direction”. A side (−θ side) in the circumferential direction which is opposite to the side facing the arrow θ is referred to as “the other side in the circumferential direction”. The one side in the circumferential direction is a side that moves clockwise around the central axis J when viewed from the right side (+Y side). The other side in the circumferential direction is a side that moves counterclockwise around the central axis J when viewed from the right side.

### First Preferred Embodiment

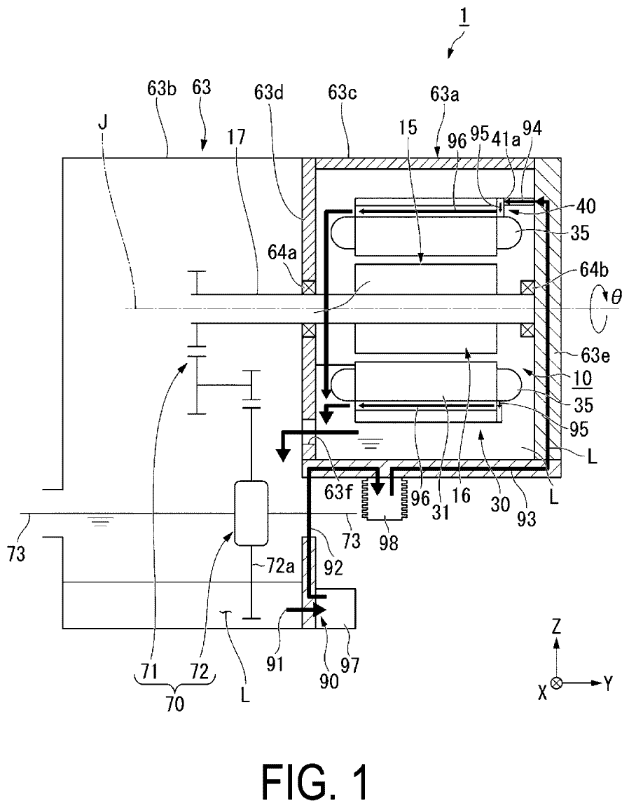

A drive device 1 of the present embodiment illustrated in FIG. 1 is mounted on a vehicle and rotates an axle 73. Vehicles on which the drive device 1 can be mounted are vehicles with a motor as a drive source, such as hybrid electric vehicles (HEVs), plug-in hybrid electric vehicles (PHVs), and electric vehicles (EVs). The drive device 1 includes a rotating electric machine 10, a gear mechanism 70 connected to the rotating electric machine 10, a housing 63 that accommodates the rotating electric machine 10 and the gear mechanism 70, and a refrigerant flow path 90. In the present embodiment, the rotating electric machine 10 is a motor.

The housing 63 accommodates the rotating electric machine 10 and the gear mechanism 70. The housing 63 includes a motor housing 63a that accommodates the rotating electric machine 10 therein, and a gear housing 63b that accommodates the gear mechanism 70 therein. The motor housing 63a is connected to the right side (+Y side) of the gear housing 63b. The motor housing 63a accommodates a refrigerant L therein. The refrigerant L is stored in a lower region within the motor housing 63a. The motor housing 63a includes a circumferential wall portion 63c, a partition wall portion 63d, and a lid portion 63e. The circumferential wall portion 63c and the partition wall portion 63d are, for example, portions of the same single member. The lid portion 63e is, for example, separate from the circumferential wall portion 63c and the partition wall portion 63d.

The circumferential wall portion 63c has a cylindrical shape that surrounds the central axis J and opens to the right (+Y side). The circumferential wall portion 63c surrounds the rotating electric machine 10 from the outer side in the radial direction. The partition portion 63d is connected to an end on the left side (−Y side) of the circumferential wall portion 63c. The partition portion 63d axially separates the inside of the motor housing 63a from the inside of the gear housing 63b. The partition portion 63d includes a partition opening 63f that connects the inside of the motor housing 63a with the inside of the gear housing 63b. The partition portion 63d holds a bearing 64a. The lid portion 63e is fixed to an end on the right side of the circumferential wall portion 63c. The lid portion 63e closes the opening of the circumferential wall portion 63c. The lid portion 63e holds a bearing 64b.

The gear housing 63b accommodates a refrigerant L therein. The refrigerant L is stored in a lower region within the gear housing 63b. The refrigerant L circulates through the refrigerant flow path 90. In the present embodiment, the refrigerant L is lubricating oil that cools the rotating electric machine 10 and lubricates the gear mechanism 70. For example, in order to achieve cooling and lubrication functions, it is preferable to use a relatively low-viscosity oil equivalent to automatic transmission lubricating oil (ATF: Automatic Transmission Fluid) as the refrigerant L.

The gear mechanism 70 is connected to a rotor 15 (described below) of the rotating electric machine 10 and transmits the rotation of the rotor 15 to an axle 73 of the vehicle. In the present embodiment, the gear mechanism 70 includes a reduction gear 71 connected to the rotor 15 and a differential gear 72 connected to the reduction gear 71. The differential gear 72 includes a ring gear 72a. A torque output from the rotating electric machine 10 is transmitted to the ring gear 72a via the reduction gear 71. A lower end of the ring gear 72a is immersed in the refrigerant L stored in the gear housing 63b. When the ring gear 72a rotates, the refrigerant L is stirred up, and the stirred-up refrigerant L lubricates the reduction gear 71 and the differential gear 72.

The rotating electric machine 10 includes a rotor 15 that is rotatable about the central axis J, a stator 30 that faces the rotor 15 in the radial direction with a gap therebetween, and a guide member 40. Each of the rotor 15, the stator 30, and the guide member 40 is accommodated in the housing 63. In more detail, each of the rotor 15, the stator 30, and the guide member 40 is accommodated in the motor housing 63a. In the present embodiment, the stator 30 is disposed outside the rotor 15 in the radial direction. The stator 30 and the guide member 40 are fixed to the motor housing 63a. The rotor 15 includes a rotor core 16 and a shaft 17.

The shaft 17 has a cylindrical shape that extends axially about the central axis J. The shaft 17 may also have a columnar shape that extends axially about the central axis J. The shaft 17 is disposed inside the motor housing 63a. The left end of the shaft 17 protrudes into the gear housing 63b. The right end of the shaft 17 is rotatably supported by the bearing 64b. A portion on the left side (−Y side) of the shaft 17 is rotatably supported by the bearing 64a. Thereby, the shaft 17 is rotatable about the central axis J.

The rotor core 16 has a substantially annular shape centered on the central axis J. The rotor core 16 is made of a magnetic material. The rotor core 16 is fixed to the outer circumferential surface of the shaft 17. Thereby, the rotor core 16 is rotatable about the central axis J. That is, the rotor 15 is rotatable about the central axis J. A plurality of magnets (not shown) are fixed to the rotor core 16. The magnets are disposed in the circumferential direction.

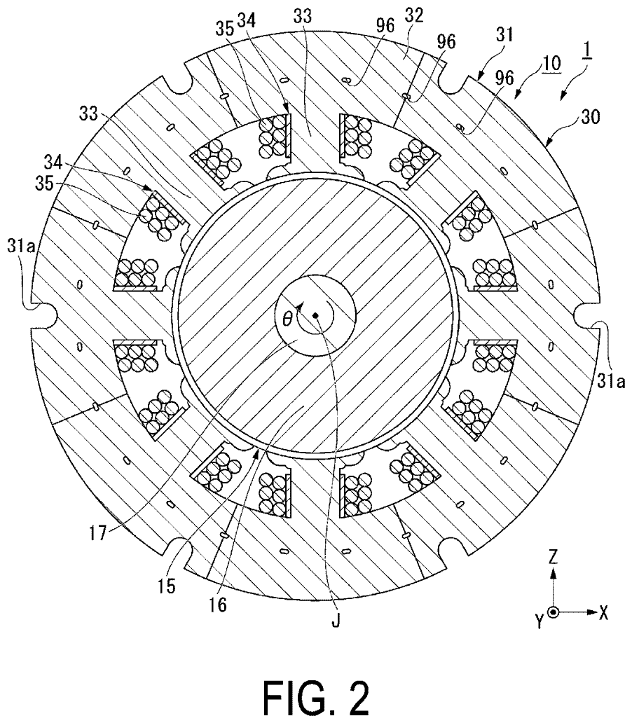

As illustrated in FIG. 2, the stator 30 includes a stator core 31, an insulator 34, and a coil portion 35. The stator core 31 has an annular shape centered on the central axis J. In the present embodiment, the stator core 31 has a substantially annular shape centered on the central axis J. The stator core 31 may have another shape, such as an octagonal shape. The stator core 31 surrounds the rotor core 16 from the outside in the radial direction. The stator core 31 faces the rotor 15 in the radial direction with a gap therebetween. The stator core 31 includes a core back portion 32, a plurality of teeth 33, and first fastening hole portions 31a. The stator core 31 is provided with a plurality of stator flow paths 96.

The core back portion 32 has an annular shape centered on the central axis J. In the present embodiment, the core back portion 32 has a substantially annular shape centered on the central axis J. Each of the plurality of teeth 33 protrudes from the core back portion 32 in the radial direction. In the present embodiment, the teeth 33 protrude inward in the radial direction from the inner circumferential surface of the core back portion 32. In the present embodiment, the stator 30 includes eight teeth 33. The number of teeth 33 included in the stator 30 may be seven or less or may be nine or more. The teeth 33 are disposed at substantially equal intervals in the circumferential direction along the inner circumferential surface of the core back portion 32. The teeth 33 face the rotor core 16 in the radial direction with a gap therebetween.

The first fastening hole portion 31a is a hole that penetrates the stator core 31 in the axial direction. The stator core 31 includes a plurality of first fastening hole portions 31a. In the present embodiment, the stator core 31 includes six first fastening hole portions 31a. The number of first fastening hole portions 31a provided in the stator core 31 may be five or less or may be seven or more. The first fastening hole portions 31a are disposed at substantially equal intervals in the circumferential direction. Each first fastening hole portion 31a is provided on the outer edge of the stator core 31 in the radial direction. In the present embodiment, each first fastening hole portion 31a opens outward in the radial direction. The inner side surface of each first fastening hole portion 31a is connected to the outer circumferential surface of the stator core 31. Each first fastening hole portion 31a does not have to open outward in the radial direction.

The plurality of stator flow paths 96 are holes that penetrate the stator core 31 in the axial direction. When viewed in the axial direction, each stator flow path 96 has an elongated hole shape that extends in the circumferential direction. When viewed in the axial direction, each stator flow path 96 may have another shape, such as a circular shape or a rectangular shape. As illustrated in FIG. 1, a refrigerant L flows through each stator flow path 96. As illustrated in FIG. 2, in the present embodiment, 24 stator flow paths 96 are provided in the stator core 31. The number of stator flow paths 96 provided in the stator core 31 may be 23 or less, or 25 or more. The stator flow paths 96 are disposed at intervals in the circumferential direction. That is, the plurality of stator flow paths 96 are disposed at different positions in the circumferential direction. In the present embodiment, the plurality of stator flow paths 96 are provided in the core back portion 32.

The insulator 34 insulates the stator core 31 from the coil portion 35. The insulator 34 is attached to each of the plurality of teeth 33. The coil portion 35 is attached to the teeth 33. In the present embodiment, the stator 30 has eight coil portions 35. The coil portions 35 are attached to different teeth 33 via the insulators 34. As illustrated in FIG. 1, a portion of each coil portion 35 on one side in the axial direction is positioned on one side of the stator core 31 in the axial direction. A portion of each coil portion 35 on the other in the axial direction is positioned on the other side of the stator core 31 in the axial direction.

Although not shown in the drawing, the coil portions 35 are electrically connected to an external power supply (not shown). When a current is supplied to the coil portions 35 from the external power supply, the coil portions 35 configure an electromagnet. At this time, heat due to iron loss and Joule heat are generated in each coil portion 35, causing the temperature of each coil portion 35 to rise. The heat generated in each coil portion 35 is also transferred to the stator core 31. Thereby, the temperature of the stator 30 including the stator core 31 rises. When the temperature of each coil portion 35 becomes excessively high, there is a risk that the coil portions 35 will deteriorate. For this reason, in the present embodiment, heat generated in each coil portion 35 is transferred via the stator core 31 to the refrigerant L flowing inside each stator flow path 96, and thus is discharged to the outside of the rotating electric machine 10. This prevents the temperature of the stator 30, and in particular the coil portions 35, from becoming excessively high.

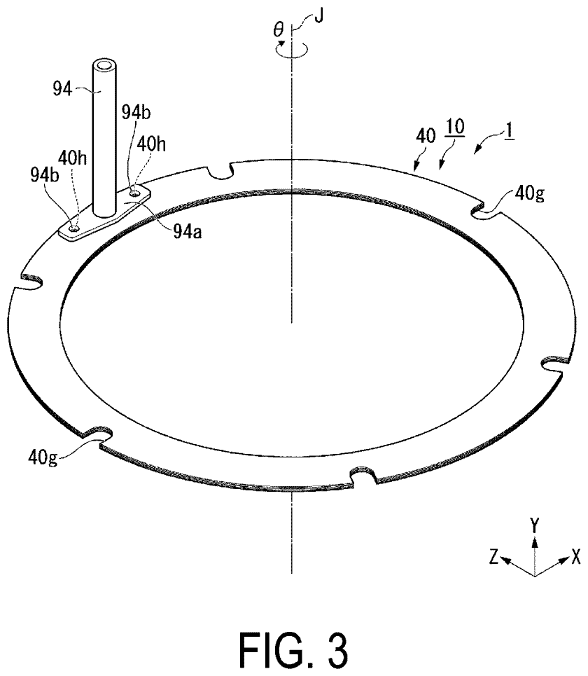

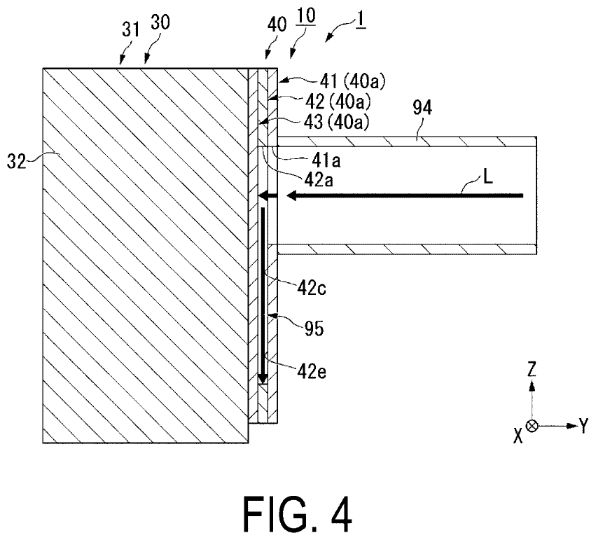

As illustrated in FIG. 3, the guide member 40 has a plate shape that extends in a direction orthogonal to the axial direction. In the present embodiment, the guide member 40 has a substantially annular plate shape centered on the central axis J. The guide member 40 may have another shape, such as an octagonal shape, centered on the central axis J. As illustrated in FIG. 4, the guide member 40 is disposed on one side of the stator core 31 in the axial direction. The guide member 40 is fixed to the surface of the stator core 31 which faces one side in the axial direction using an adhesive. The guide member 40 contacts the surface of the stator core 31 which faces one side in the axial direction. That is, the guide member 40 is in contact with the stator core 31 in the axial direction. As illustrated in FIG. 1, the guide member 40 faces the coil portion 35 in the radial direction. Thus, according to the present embodiment, the guide member 40 can be disposed closer to the stator core 31 in the axial direction than when the guide member 40 is disposed to face the coil portion 35 in the axial direction, that is, on one side of the coil portion 35 in the axial direction. Thus, it is possible to prevent the rotating electric machine 10 and the drive device 1 from becoming larger in the axial direction.

The guide member 40 includes a connection flow path portion 95 that connects the plurality of stator flow paths 96. As illustrated in FIG. 3, the guide member 40 includes second fastening hole portions 40g and mounting hole portions 40h. As illustrated in FIG. 4, the guide member 40 is configured with a plurality of flow path members 40a stacked in the axial direction.

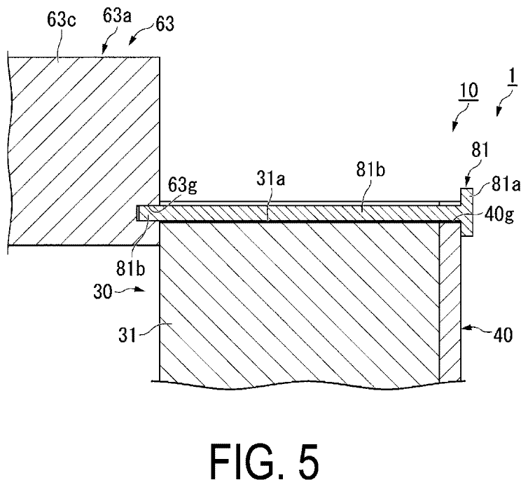

The second fastening hole portions 40g are holes that penetrate the guide member 40 in the axial direction. As illustrated in FIG. 3, the guide member 40 includes a plurality of second fastening hole portions 40g. In the present embodiment, the guide member 40 includes six second fastening hole portions 40g. The second fastening hole portions 40g are disposed at substantially equal intervals in the circumferential direction. The second fastening hole portions 40g are disposed on the outer edge portion of the guide member 40 in the radial direction. In the present embodiment, each second fastening hole portion 40g opens outward in the radial direction. The second fastening hole portions 40g do not have to open outward in the radial direction. As illustrated in FIG. 5, when viewed in the axial direction, the second fastening hole portions 40g overlap different first fastening hole portions 31a.

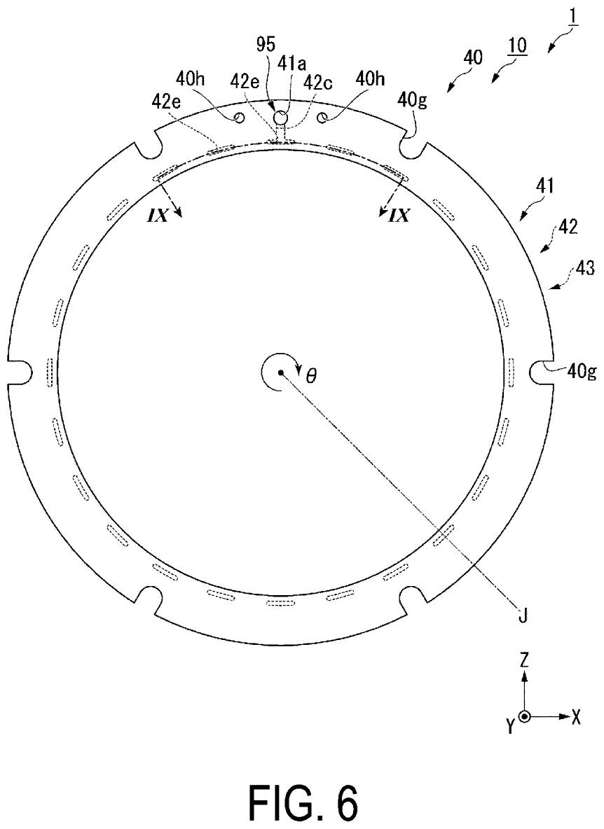

As illustrated in FIG. 6, the mounting hole portion 40h is a hole that penetrates the guide member 40 in the axial direction. When viewed in the axial direction, the mounting hole portion 40h is a hole having a substantially circular shape. In the present embodiment, the mounting hole portion 40h is a female screw hole. In the present embodiment, the guide member 40 includes two mounting hole portions 40h. Each mounting hole portion 40h is provided in a portion on the upper side (+Z side) of the guide member 40. The mounting hole portions 40h are disposed at intervals in the front-back direction (X-axis direction).

As illustrated in FIG. 4, in the present embodiment, the plurality of flow path members 40a include a first flow path member 41, a second flow path member 42, and a third flow path member 43. Each of the first flow path member 41, the second flow path member 42, and the third flow path member 43 has a plate shape that extends in a direction orthogonal to the axial direction. The first flow path member 41, the second flow path member 42, and the third flow path member 43 are disposed in this order from one side in the axial direction. In the present embodiment, the first flow path member 41, the second flow path member 42, and the third flow path member 43 are fixed to each other using an adhesive. Thereby, the first flow path member 41, the second flow path member 42, and the third flow path member 43 configure the guide member 40.

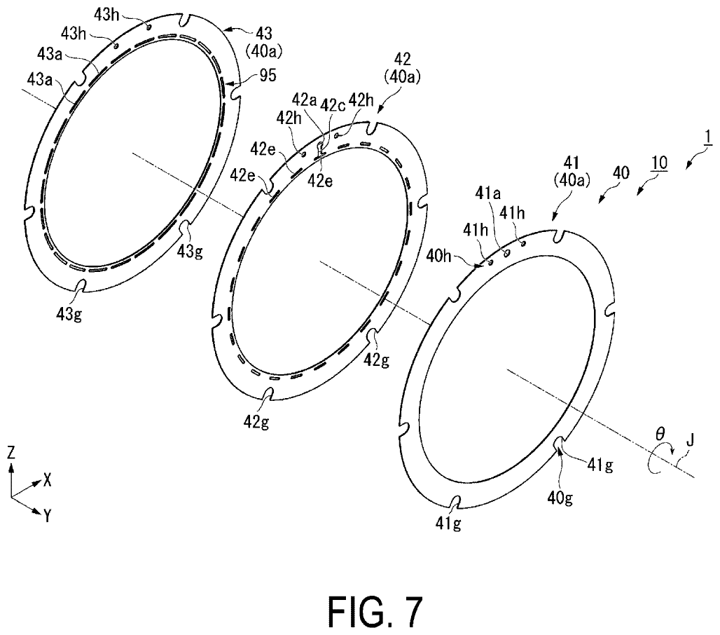

As illustrated in FIG. 7, in the present embodiment, the first flow path member 41 has a substantially annular plate shape centered on the central axis J. The first flow path member 41 may have another shape, such as an octagonal shape centered on the central axis J. The first flow path member 41 includes a first inflow hole 41a, a fastening hole 41g, and a mounting hole 41h. The first inflow hole 41a, the fastening hole 41g, and the mounting hole 41h are holes that penetrate the first flow path member 41 in the axial direction.

The first inflow hole 41a is provided in a portion on the upper side (+Z side) of the first flow path member 41. In the present embodiment, the first inflow hole 41a is a hole having a circular shape when viewed in the axial direction. The first flow path member 41 includes six fastening holes 41g. The fastening holes 41g are disposed at substantially equal intervals in the circumferential direction. The fastening holes 41g are disposed on the outer edge of the first flow path member 41 in the radial direction. Each fastening hole 41g opens outward in the radial direction. Each fastening hole 41g configures a portion of each second fastening hole portion 40g illustrated in FIG. 3.

When viewed in the axial direction, the mounting hole 41h is a hole having a substantially circular shape. The first flow path member 41 includes two mounting holes 41h. Each mounting hole 41h is provided in a portion on the upper side (+Z side) portion of the first flow path member 41. The mounting holes 41h are disposed at intervals in the front-back direction (X-axis direction). The mounting holes 41h are disposed to sandwich the first inflow hole 41a in the front-back direction. Each mounting hole 41h configures a portion of each mounting hole portion 40h illustrated in FIG. 3.

In the present embodiment, the second flow path member 42 has a substantially annular plate shape centered on the central axis J. The second flow path member 42 may have another shape, such as an octagonal shape, centered on the central axis J. As illustrated in FIG. 4, the second flow path member 42 is disposed on the other side of the first flow path member 41 in the axial direction. As illustrated in FIG. 7, the second flow path member 42 includes a second flow path portion 42a, a first communication hole 42c, a plurality of first connection holes 42e, a fastening hole 42g, and a mounting hole 42h. The second flow path portion 42a, the first communication hole 42c, the plurality of first connection holes 42e, the fastening hole 42g, and the mounting hole 42h are holes that penetrate the second flow path member 42 in the axial direction.

The second flow path portion 42a is provided in a portion on the upper side (+Z side) of the second flow path member 42. In the present embodiment, the second flow path portion 42a is a hole having a circular shape when viewed in the axial direction. The second flow path portion 42a may be a hole recessed from the surface of the second flow path member 42, which faces one side in the axial direction, toward the other side in the axial direction. When viewed in the axial direction, at least a portion of the second flow path portion 42a overlaps at least a portion of the first inflow hole 41a. Thereby, the second flow path portion 42a is connected to the first inflow hole 41a in the axial direction.

The first communication hole 42c is a hole extending downward (−Z side) from the second flow path portion 42a. The first communication hole 42c is connected to the second flow path portion 42a in the radial direction. Each of the plurality of first connection holes 42e is an elongated hole extending in the circumferential direction. In the present embodiment, the second flow path member 42 includes 24 first connection holes 42e. The plurality of first connection holes 42e are disposed at substantially equal intervals in the circumferential direction. Among the plurality of first connection holes 42e, the first connection hole 42e disposed on the uppermost side (+Z side) is connected to the first communication hole 42c. Thereby, at least one first connection hole 42e is connected to the second flow path portion 42a via the first communication hole 42c. As illustrated in FIG. 6, the plurality of first connection holes 42e are disposed below (−Z side) the first inflow hole 41a. That is, the first inflow hole 41a is disposed on the upper side (+Z side) of the plurality of first connection holes 42e in the vertical direction.

As illustrated in FIG. 7, the second flow path member 42 includes six fastening holes 42g. The fastening holes 42g are disposed at substantially equal intervals in the circumferential direction. The fastening holes 42g are disposed on the outer edge of the second flow path member 42 in the radial direction. Each fastening holes 42g opens outward in the radial direction. When viewed in the axial direction, the fastening holes 42g overlap different fastening holes 41g. Each fastening hole 42g configures a portion of each second fastening hole portion 40g illustrated in FIG. 3.

When viewed in the axial direction, the mounting hole 42h is a hole having a substantially circular shape. The second flow path member 42 has two mounting holes 42h. Each mounting hole 42h is provided in a portion on the upper side (+Z side) of the second flow path member 42. The mounting holes 42h are disposed at intervals in the front-back direction (X-axis direction). The mounting holes 42h are disposed to sandwich the second flow path portion 42a in the front-back direction. When viewed in the axial direction, the mounting holes 42h overlap different mounting holes 41h. Each mounting hole 42h configures a portion of each mounting hole portion 40h illustrated in FIG. 3.

In the present embodiment, the third flow path member 43 has a substantially annular plate shape centered on the central axis J. The third flow path member 43 may have another shape, such as an octagonal shape centered on the central axis J. As illustrated in FIG. 4, the third flow path member 43 is disposed between the second flow path member 42 and the stator core 31. The surface of the third flow path member 43 which faces the other side in the axial direction is fixed to the stator core 31 using an adhesive. The third flow path member 43 contacts the stator core 31. As illustrated in FIG. 7, the third flow path member 43 includes a plurality of second connection holes 43a, fastening holes 43g, and mounting holes 43h. Each of the plurality of second connection holes 43a, fastening holes 43g, and mounting holes 43h is a hole that penetrates the third flow path member 43 in the axial direction.

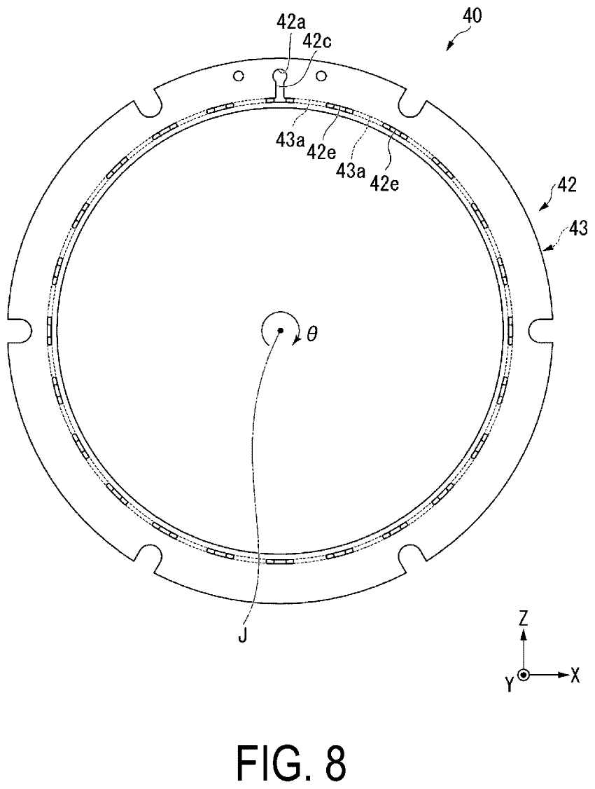

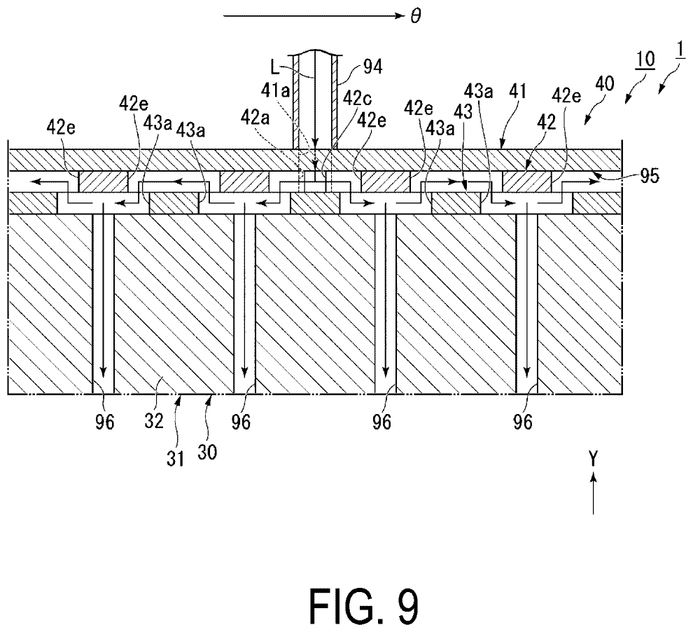

Each of the plurality of second connection holes 43a is an elongated hole extending in the circumferential direction. In the present embodiment, the third flow path member 43 includes 24 second connection holes 43a. The plurality of second connection holes 43a are disposed at substantially equal intervals in the circumferential direction. As illustrated in FIG. 8, each of the plurality of second connection holes 43a overlaps the first connection hole 42e when viewed in the axial direction. In more detail, each of the plurality of second connection holes 43a overlaps a pair of first connection holes 42e disposed adjacent to each other in the circumferential direction when viewed in the axial direction. Thereby, as illustrated in FIG. 9, a portion of each second connection hole 43a on the other side (−θ side) in the circumferential direction is connected in the axial direction to the first connection hole 42e disposed on the other side of the pair of first connection holes 42e in the circumferential direction. A portion of each second connection hole 43a on one side (+θ side) in the circumferential direction is connected in the axial direction to the first connection hole 42e disposed on one side of the pair of first connection holes 42e in the circumferential direction. Thereby, the pair of first connection holes 42e disposed adjacent to each other in the circumferential direction are connected to each other via the second connection hole 43a. A pair of second connection holes 43a disposed adjacent to each other in the circumferential direction are connected to each other via the first connection hole 42e.

When viewed in the axial direction, each of the plurality of stator flow paths 96 overlaps the second connection hole 43a. In more detail, in the present embodiment, when viewed in the axial direction, the plurality of stator flow paths 96 overlap different second connection holes 43a. Thereby, each stator flow path 96 is connected to the first inflow hole 41a via the second flow path portion 42a, the first communication hole 42c, the plurality of first connection holes 42e, and the plurality of second connection holes 43a. In the present embodiment, the connection flow path portion 95 is configured with the first inflow hole 41a, the second flow path portion 42a, the first communication hole 42c, the plurality of first connection holes 42e, and the plurality of second connection holes 43a. The connection flow path portion 95 connects the plurality of stator flow paths 96 that are disposed at positions that are different from each other in the circumferential direction. As illustrated in FIG. 1, in the present embodiment, a distance between the stator flow path 96 and the central axis J in the radial direction is shorter than a distance between the first inflow hole 41a and the central axis J in the radial direction.

As illustrated in FIG. 7, the third flow path member 43 includes six fastening holes 43g. The fastening holes 43g are disposed at substantially equal intervals in the circumferential direction. The fastening holes 43g are disposed on the outer edge of the third flow path member 43 in the radial direction. Each fastening hole 43g opens outward in the radial direction. When viewed in the axial direction, the fastening holes 43g overlap different fastening holes 41g and different fastening holes 42g. Each fastening hole 43g configures a portion of each second fastening hole portion 40g illustrated in FIG. 3. As described above, each fastening hole 41g and each fastening hole 42g configure a portion of each second fastening hole portion 40g. That is, each second fastening hole portion 40g is configured with the fastening holes 41g, 42g, and 43g.

As illustrated in FIG. 5, when a fastening member 81 passes through each of the first fastening hole portion 31a and the second fastening hole portion 40g in the axial direction, and a male thread portion 81b of the fastening member 81 is fastened to a female thread hole 63g provided in the circumferential wall portion 63c of the housing 63, a head 81a of the fastening member 81 presses the stator core 31 and the guide member 40 against the circumferential wall portion 63c. Thereby, the stator 30 and the guide member 40 are fixed to the housing 63. According to the present embodiment, the stator core 31 and the guide member 40 are fixed to the housing 63 by the fastening member 81 that passes through each of the first fastening hole portion 31a and the second fastening hole portion 40g in the axial direction and is fastened to the housing 63. Thereby, the stator 30 and guide member 40 can be fixed to the housing 63 using the same fastening member 81. For this reason, as compared to a configuration in which the stator 30 and the guide member 40 are separately fixed to the housing 63 using different fastening members, it is possible to curb an increase in the number of fastening members 81. Thus, it is possible to curb increases in the number of parts and manufacturing costs of the rotating electric machine 10 and the drive device 1.

In the present embodiment, as described above, the stator 30 and the guide member 40 can be fixed to the housing 63 using the same fastening member 81, and thus it is possible to simplify the work of fixing the stator 30 and the guide member 40 to the housing 63 in the assembly process of the rotating electric machine 10. Thus, it is possible to curb an increase in the number of manufacturing steps for the rotating electric machine 10 and the drive device 1.

In the present embodiment, the head 81a of the fastening member 81 presses the stator core 31 against the housing 63 via the guide member 40. Thereby, the head 81a of the fastening member 81 can be prevented from coming into direct contact with the stator core 31, and thus it is possible to reduce the stress applied to the stator core 31 by the head 81a of the fastening member 81. Thus, even when the stator core 31 is made of, for example, a metal material having an amorphous structure with a small fracture strain, it is possible to curb damage to the stator core 31.

As illustrated in FIG. 7, when viewed in the axial direction, the mounting hole 43h is a hole having a substantially circular shape. The third flow path member 43 includes two mounting holes 43h. Each mounting hole 43h is provided in a portion on the upper side (+Z side) of the third flow path member 43. The mounting holes 43h are disposed at intervals in the front-back direction (X-axis direction). When viewed in the axial direction, the mounting holes 43h overlap different mounting holes 41h and different mounting holes 42h. Each mounting hole 43h configures a portion of the mounting hole portion 40h illustrated in FIG. 3. As described above, each mounting hole 41h and each mounting hole 42h configure a portion of each mounting hole portion 40h. That is, each mounting hole portion 40h is configured with mounting holes 41h, 42h, and 43h.

As illustrated in FIG. 1, the refrigerant flow path 90 is a path that supplies the refrigerant L stored in the gear housing 63b and the motor housing 63a to the stator 30. A pump 97 and a cooler 98 are provided in the refrigerant flow path 90. The refrigerant flow path 90 includes a first flow path portion 91, a second flow path portion 92, a third flow path portion 93, a supply flow path portion 94, a connection flow path portion 95, and a stator flow path 96.

The first flow path portion 91, the second flow path portion 92, and the third flow path portion 93 are provided, for example, in the wall portion of the motor housing 63a. The first flow path portion 91 connects the pump 97 to a lower region in the gear housing 63b where the refrigerant L is stored. The second flow path portion 92 connects the pump 97 to the cooler 98. The third flow path portion 93 connects the cooler 98 to the supply flow path portion 94.

The supply flow path portion 94 is a pipe extending in the axial direction. The supply flow path portion 94 connects the third flow path portion 93 and the connection flow path portion 95. The supply flow path portion 94 is disposed on one side in the axial direction rather than the guide member 40. The supply flow path portion 94 faces the coil portion 35 in the radial direction. An end on one side of the supply flow path portion 94 in the axial direction is supported by the motor housing 63a. An end on one side of the supply flow path portion 94 in the axial direction is connected to the third flow path portion 93. As illustrated in FIG. 3, a flange portion 94a is provided at an end on the other side of the supply flow path portion 94 in the axial direction. The flange portion 94a has a plate shape that protrudes on both sides in the front-back direction (X-axis direction) from the supply flow path portion 94. The flange portion 94a is provided with two through holes 94b that penetrate the flange portion 94a in the axial direction. The through holes 94b are disposed to sandwich the supply flow path portion 94 in the front-back direction. When viewed in the axial direction, the through holes 94b overlap different mounting hole portions 40h of the guide member 40. When a screw (not shown) passes through each through hole 94b and is fastened into each mounting hole portion 40h, the flange portion 94a is fixed to the guide member 40. Thereby, the supply flow path portion 94 is fixed to the guide member 40. Thereby, as illustrated in FIG. 4, an end on the other side of the supply flow path portion 94 in the axial direction is connected to the first inflow hole 41a. That is, the supply flow path portion 94 and the connection flow path portion 95 are connected.

As illustrated in FIG. 9, the connection flow path portion 95 connects the supply flow path portion 94 and the plurality of stator flow paths 96. As described above, the connection flow path portion 95 is configured with the first inflow hole 41a, the second flow path portion 42a, the first communication hole 42c, the plurality of first connection holes 42e, and the plurality of second connection holes 43a.

As illustrated in FIG. 1, each of the plurality of stator flow paths 96 extends in the axial direction inside the stator core 31. An end on one side of each stator flow path 96 in the axial direction is connected to the connection flow path portion 95. An end on the other side of each stator flow path 96 in the axial direction opens inside the motor housing 63a.

When the pump 97 is driven, the refrigerant L stored in the lower region of the gear housing 63b is suctioned into the pump 97 through the first flow path portion 91, and the refrigerant L discharged from the pump 97 flows into the cooler 98 through the second flow path portion 92. The refrigerant L that flows into the cooler 98 is cooled inside the cooler 98, and then passes through the third flow path portion 93 and flows into the supply flow path portion 94. As illustrated in FIG. 9, the refrigerant L that flows into the supply flow path portion 94 is supplied to the connection flow path portion 95. That is, the supply flow path portion 94 supplies the refrigerant L to the connection flow path portion 95.

The refrigerant L supplied to the connection flow path portion 95 passes through the first inflow hole 41a, the second flow path portion 42a, and the first communication hole 42c and then flows into the first connection hole 42e. The refrigerant L having flowed into the first connection hole 42e flows toward both sides in the circumferential direction while alternately passing through the second connection hole 43a and the first connection hole 42e. That is, the guide member 40 supplies the refrigerant L in the circumferential direction. A portion of the refrigerant L flowing toward both sides in the circumferential direction flows into each stator flow path 96. Thereby, the refrigerant L flows into the stator flow paths 96 disposed at different positions in the circumferential direction.

The refrigerant L having flowed into each stator flow path 96 absorbs heat from the stator 30 by coming into contact with the inner side surface of each stator flow path 96. Thereby, heat due to iron loss and Joule heat generated in the coil portion 35 are transferred to the refrigerant L, and thus the stator 30 is cooled. As illustrated in FIG. 1, the refrigerant L having absorbed heat from the stator 30 flows into the motor housing 63a from an opening on the other side in the axial direction of each stator flow path 96 and is stored in the lower region within the motor housing 63a.

In the present embodiment, a portion on the lower side (−Z side) of the stator 30 is immersed in the refrigerant L stored in the lower region of the motor housing 63a. A lower portion of the stator core 31 and the coil portion 35 attached to the portion on the lower side of the stator core 31 are immersed in the refrigerant L. Thereby, heat from the lower portion of the stator 30 is transferred to the refrigerant L, thereby cooling the lower portion of the stator 30. The refrigerant L stored in the lower region of the motor housing 63a flows into the gear housing 63b through the partition opening 63f and is stored again in the lower region of the gear housing 63b.

According to the present embodiment, the stator core 31 is provided with a plurality of stator flow paths 96 that penetrate the stator core 31 in the axial direction and through which the refrigerant L flows. The plurality of stator flow paths 96 are disposed at different positions in the circumferential direction. The guide member 40 includes the connection flow path portion 95 that connects the plurality of stator flow paths 96, and is configured with a plurality of flow path members 40a stacked in the axial direction. Thus, the connection flow path portion 95 allows the refrigerant L to be supplied to the stator flow paths 96 disposed at different positions in the circumferential direction. Thereby, heat from the stator core 31 can be transferred to the refrigerant L flowing through the stator flow paths 96, and thus it is possible to suitably cool the stator 30 over a wide range in the circumferential direction. Thus, it is possible to curb a rise in the temperature of the entire stator 30. Accordingly, it is possible to prevent the temperature of some of the plurality of coil portions 35 disposed in the circumferential direction from becoming excessively high, and thus deterioration of the coil portions 35 can be curbed. Thus, it is possible to improve the stability of operations of the rotating electric machine 10 and the drive device 1.

In the present embodiment, the connection flow path portion 95 can be configured by the shapes of holes or the like provided in each of the plurality of flow path members 40a stacked in the axial direction. Thereby, it is easy to improve the degree of freedom in the shape of the connection flow path portion 95 as compared to a case where the guide member 40 is configured with a single member, thereby making it easier to configure the shape of the connection flow path portion 95 in accordance with the positions of the supply flow path portion 94 and the stator flow paths 96. This makes it easier to curb variations in a flow rate of the refrigerant L flowing through each stator flow path 96, and thus it is possible to suitably curb variations in the temperature of the stator core 31 in the circumferential direction. Thus, it is possible to suitably curb a rise in the temperature of the entire stator 30.

According to the present embodiment, the guide member 40 is in contact with the stator core 31 in the axial direction. Thus, heat from the stator core 31 can be transferred via the guide member 40 to the refrigerant L flowing through the connection flow path portion 95. Thereby, the amount of heat transferred from the stator core 31 to the refrigerant L can be increased, and thus it is possible to more suitably curb a rise in the temperature of the stator 30.

According to the present embodiment, the first flow path member 41, the second flow path member 42, and the third flow path member 43 each have a plate shape that extends in a direction orthogonal to the axial direction. The first flow path member 41 includes a first inflow hole 41a penetrating the first flow path member 41 in the axial direction. The second flow path member 42 includes a second flow path portion 42a connected to the first inflow hole 41a and a plurality of first connection holes 42e. The third flow path member 43 includes a plurality of second connection holes 43a penetrating the third flow path member 43 in the axial direction. When viewed in the axial direction, at least a portion of the second flow path portion 42a overlaps at least a portion of the first inflow hole 41a. The plurality of first connection holes 42e are disposed at intervals in the circumferential direction. At least one first connection hole 42e is connected to the second flow path portion 42a. The plurality of second connection holes 43a are disposed at intervals in the circumferential direction and overlap the first connection holes 42e when viewed in the axial direction. When viewed in the axial direction, each of the plurality of stator flow paths 96 overlaps the second connection holes 43a. In the present embodiment, the first inflow hole 41a, the second flow path portion 42a, the plurality of first connection holes 42e, and the plurality of second connection holes 43a can be formed by processing the first flow path member 41, the second flow path member 42, and the third flow path member 43, which have a plate shape, using a simple processing method such as press working. Through the simple work of stacking the first flow path member 41, the second flow path member 42, and the third flow path member 43 in the axial direction, it is possible to configure the connection flow path portion 95 capable of supplying the refrigerant L to each of the stator flow paths 96 that are disposed at different positions in the circumferential direction. Thus, it is possible to curb increases in manufacturing costs and the number of manufacturing steps for the guide member 40.

In the present embodiment, as described above, the connection flow path portion 95 can be configured by processing each of the first flow path member 41, the second flow path member 42, and the third flow path member 43, which have a plate shape, using a processing method such as press working, and thus it is possible to more improve the degree of freedom in the shape of the connection flow path portion 95. Thereby, the shape of the connection flow path portion 95 can be configured in accordance with the positions of the supply flow path portion 94 and the stator flow paths 96, thereby making it easier to more suitably curb variations in a flow rate of the refrigerant L flowing through the stator flow paths 96. Thus, it is possible to more suitably curb variations in the temperature of the stator core 31 in the circumferential direction, thereby making it possible to more suitably curb a rise in the temperature of the entire stator 30.

In the present embodiment, each of the plurality of first connection holes 42e and the plurality of second connection holes 43a is a hole extending in the circumferential direction. Accordingly, even when the position of the third flow path member 43 in the circumferential direction is shifted from the second flow path member 42 during the manufacturing process of the guide member 40, it is easy to dispose the first connection holes 42e and the second connection holes 43a so that they overlap each other in the axial direction. Even when the position of the third flow path member 43 in the circumferential direction is shifted from the stator core 31 during the assembly process of the rotating electric machine 10, it is easy to disposed the second connection holes 43a and the stator flow paths 96 so that they overlap each other in the axial direction. Thereby, it is possible to stably supply the refrigerant L to the stator flow paths 96 via the connection flow path portion 95. Thus, it is possible to more suitably curb variations in the flow rate of the refrigerant L flowing through the stator flow paths 96, thereby making it possible to more suitably curb a rise in the temperature of the entire stator 30.

In the present embodiment, as illustrated in FIG. 9, the refrigerant L flows in the circumferential direction while reciprocating in the axial direction between the first connection hole 42e and the second connection hole 43a, thereby making it possible to increase a contact area between the refrigerant L and the inner surface of the connection flow path portion 95. Thereby, it is possible to more increase the amount of heat transferred from the stator core 31 to the refrigerant L flowing through the connection flow path portion 95 via the guide member 40. Thus, it is possible to more increase the amount of heat transferred from the stator core 31 to the refrigerant L, making it possible to more suitably curb a rise in the temperature of the stator 30.

According to the present embodiment, a distance between the stator flow path 96 and the central axis J in the radial direction is shorter than a distance between the first inflow hole 41a and the central axis J in the radial direction. Accordingly, it is easy to dispose the first inflow hole 41a on the outer side in the radial direction, making it easy to increase a distance between the first inflow hole 41a and the coil portion 35 in the radial direction. For this reason, when the supply flow path portion 94 is fixed to the guide member 40 during the assembly process of the rotating electric machine 10, it is easy to prevent the supply flow path portion 94 from interfering with the coil portion 35. Thus, it is possible to simplify the work of fixing the supply flow path portion 94 to the guide member 40, thereby making it possible to more suitably curb an increase in the number of manufacturing steps for the rotating electric machine 10 and the drive device 1.

In the present embodiment, the stator flow paths 96 can be easily disposed on the inner side in the radial direction, making it easy to reduce a distance between the stator flow paths 96 and the teeth 33. For this reason, heat generated in the coil portions 35 attached to the teeth 33 can be easily transferred to the refrigerant L flowing through the stator flow paths 96. Thus, it is possible to more suitably curb a rise in the temperature of the entire stator 30.

According to the present embodiment, the central axis J extends in a direction intersecting the vertical direction, and the first inflow hole 41a is disposed on the upper side (+Z side) of the plurality of first connection holes 42e in the vertical direction. Accordingly, the refrigerant L having flowed in from the first inflow hole 41a can flow into the first connection hole 42e by using gravity applied to the refrigerant L. Thereby, the flow rate of the refrigerant L flowing through the first connection hole 42e can be increased, and thus it is possible to increase the flow rate of the refrigerant L flowing through the stator flow paths 96. Thus, the amount of heat that can be transferred from the stator core 31 to the refrigerant L can be increased, and thus it is possible to more suitably curb a rise in the temperature of the entire stator 30.

According to the present embodiment, the stator core 31 includes the core back portion 32 having an annular shape and the plurality of teeth 33 protruding in the radial direction from the core back portion, and the plurality of stator flow paths 96 are provided in the core back portion 32. In the present embodiment, since the core back portion 32 has an annular shape, it is easy to increase the number of stator flow paths 96 disposed at different positions in the circumferential direction. Thus, it is possible to more suitably curb variations in the temperature of the stator core 31 in the circumferential direction, thereby making it possible to more suitably curb a rise in the temperature of the entire stator 30.

In the present embodiment, as compared to a configuration in which the plurality of stator flow paths 96 are provided in the teeth 33, it is possible to prevent a flow of magnetic flux passing through the inside of the teeth 33 from being obstructed. Thus, it is possible to curb a decrease in a magnetic force between the stator 30 and the rotor 15, thereby making it possible to prevent output torques of the rotating electric machine 10 and the drive device 1 from being decreased.

According to the present embodiment, the rotating electric machine 10 includes the supply flow path portion 94 that is connected to the connection flow path portion 95 and supplies the refrigerant L to the connection flow path portion 95, and the supply flow path portion 94 faces the coil portion 35 in the radial direction. Accordingly, as compared to a case where the supply flow path portion 94 is disposed on one side of the coil portion 35 in the axial direction, it is possible to prevent the rotating electric machine 10 and the drive device 1 from becoming larger in the axial direction.

### Second Preferred Embodiment

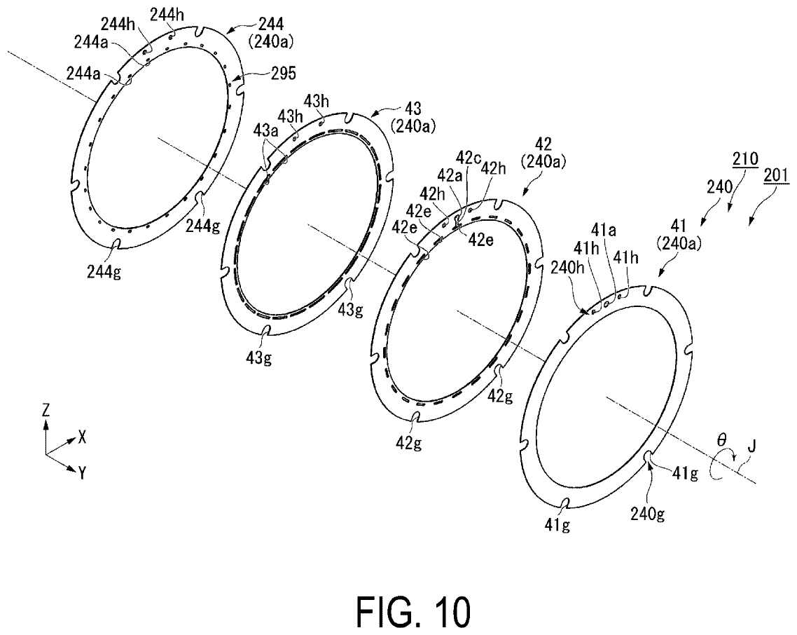

FIG. 10 is an exploded perspective view illustrating a guide member 240 of the present embodiment. In the following description, components similar to those in the first preferred embodiment described above are denoted by the same reference signs, and description thereof will be omitted.

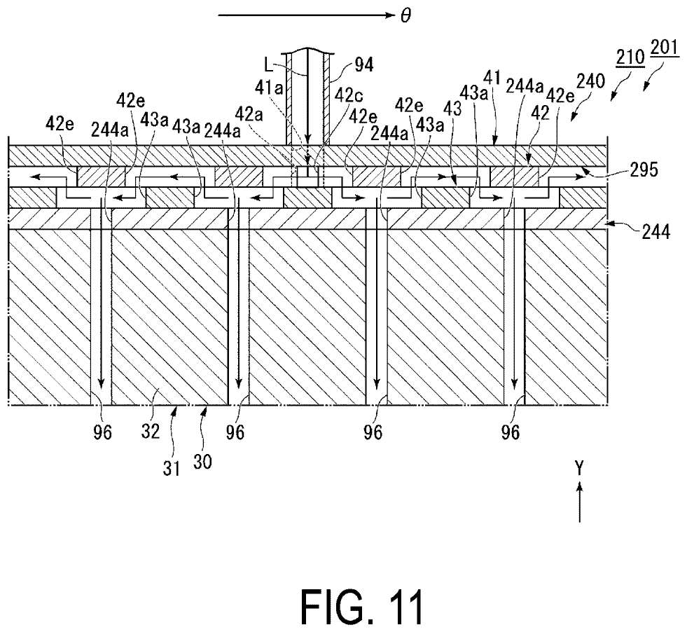

As illustrated in FIG. 11, the guide member 240 of the present embodiment includes a connection flow path portion 295 that connects a plurality of stator flow paths 96. The guide member 240 supplies a refrigerant L in the circumferential direction. As illustrated in FIG. 10, the guide member 240 includes second fastening hole portions 240g and mounting hole portions 240h. The guide member 240 is configured with a plurality of flow path members 240a stacked in the axial direction.

The second fastening hole portions 240g are holes that penetrate the guide member 240 in the axial direction. In the present embodiment, the guide member 240 includes six second fastening hole portions 240g. Each second fastening hole portion 240g is configured with fastening holes 41g, 42g, 43g, and a fastening hole 244g. The other configurations and the like of the second fastening hole portion 240g are similar to the other configurations and the like of the second fastening hole portion 40g in the first preferred embodiment described above.

The mounting hole portion 240h is a female threaded hole that penetrates the guide member 240 in the axial direction. In the present embodiment, the guide member 240 includes two mounting hole portions 240h. Each mounting hole portion 240h is configured with mounting holes 41h, 42h, 43h, and a mounting hole 244h. The other configurations and the like of the mounting hole portion 240h are similar to the other configurations and the like of the mounting hole portion 40h in the first preferred embodiment described above.

In the present embodiment, the plurality of flow path members 240a include a first flow path member 41, a second flow path member 42, a third flow path member 43, and a fourth flow path member 244. The fourth flow path member 244 has a plate shape that extends in a direction orthogonal to the axial direction. The first flow path member 41, the second flow path member 42, the third flow path member 43, and the fourth flow path member 244 are disposed in this order from one side in the axial direction. In the present embodiment, the first flow path member 41, the second flow path member 42, the third flow path member 43, and the fourth flow path member 244 are fixed to each other using an adhesive.

In the present embodiment, the fourth flow path member 244 has a substantially annular plate shape centered on the central axis J. As illustrated in FIG. 11, the fourth flow path member 244 is disposed between the third flow path member 43 and the stator core 31. The surface of the fourth flow path member 244 which faces the other side in the axial direction is fixed to the stator core 31 using an adhesive. The fourth flow path member 244 is in contact with the stator core 31. As illustrated in FIG. 10, the fourth flow path member 244 includes a plurality of outflow holes 244a, fastening holes 244g, and mounting holes 244h. The plurality of outflow holes 244a, fastening holes 244g, and mounting holes 244h are holes that penetrate the fourth flow path member 244 in the axial direction.

Each of the plurality of outflow holes 244a is an elongated hole extending in the circumferential direction. In the present embodiment, the fourth flow path member 244 includes 24 outflow holes 244a. The plurality of outflow holes 244a are disposed at substantially equal intervals in the circumferential direction. As illustrated in FIG. 11, when viewed in the axial direction, the plurality of outflow holes 244a overlap the second connection holes 43a. In more detail, when viewed in the axial direction, the outflow holes 244a overlap different second connection holes 43a. When viewed in the axial direction, the outflow holes 244a overlap the stator flow paths 96. In more detail, when viewed in the axial direction, the outflow holes 244a overlap different stator flow paths 96. In the present embodiment, the connection flow path portion 295 is configured with a first inflow hole 41a, a second flow path portion 42a, a first communication hole 42c, a plurality of first connection holes 42e, a plurality of second connection holes 43a, and a plurality of outflow holes 244a. The connection flow path portion 295 connects a plurality of stator flow paths 96 that are disposed at different positions in the circumferential direction. The other configurations and the like of the connection flow path portion 295 are similar to the configurations and the like of the connection flow path portion 95 in the first preferred embodiment described above.

As illustrated in FIG. 10, the fourth flow path member 244 includes six fastening holes 244g. The fastening holes 244g are disposed at substantially equal intervals in the circumferential direction. The fastening holes 244g are disposed on the outer edge portion of the fourth flow path member 244 in the radial direction. Each fastening hole 244g opens outward in the radial direction. When viewed in the axial direction, the fastening holes 244g overlap different fastening holes 41g, different fastening holes 42g, and different fastening holes 43g. Each fastening hole 244g configures a portion of each second fastening hole portion 240g.

When viewed in the axial direction, the mounting hole 244h is a hole having a substantially circular shape. The fourth flow path member 244 includes two mounting holes 244h. Each mounting hole 244h is provided in a portion on the upper side (+Z side) of the fourth flow path member 244. The mounting holes 244h are disposed at intervals in the front-back direction (X-axis direction). When viewed in the axial direction, the mounting holes 244h overlap different mounting holes 41h, different mounting holes 42h, and different mounting holes 43h. Each mounting hole 244h configures a portion of the mounting hole portion 240h. The other configurations and the like of the guide member 240 are similar to the configurations and the like of the guide member 40 in the first preferred embodiment described above. The other configurations and the like of the rotating electric machine 210 and the drive device 201 are similar to the other configurations and the like of the rotating electric machine 10 and the drive device 1 in the first preferred embodiment described above.

According to the present embodiment, the plurality of flow path members 240a include the fourth flow path member 244 that extends in a direction orthogonal to the axial direction. The fourth flow path member 244 is disposed between the third flow path member 43 and the stator core 31. The fourth flow path member 244 includes the plurality of outflow holes 244a that penetrate the fourth flow path member 244 in the axial direction. The plurality of outflow holes 244a are disposed at intervals in the circumferential direction and overlap the second connection holes 43a and the stator flow paths 96 when viewed in the axial direction. Thus, the refrigerant L flowing through the connection flow path portion 295 can be guided to the stator flow paths 96 by the outflow holes 244a. Thereby, the refrigerant L can be stably supplied to the stator flow paths 96 that are disposed at different positions in the circumferential direction, and thus it is possible to suitably cool the stator 30 over a wide range in the circumferential direction. Thus, it is possible to more suitably curb a rise in the temperature of the entire stator 30.

In the present embodiment, it is possible to form holes such as the plurality of outflow holes 244a by processing the fourth flow path member 244, which has a plate shape, using a simple processing method such as press working. The connection flow path portion 295 can be configured by simple work of stacking the first flow path member 41, the second flow path member 42, the third flow path member 43, and the fourth flow path member 244 in the axial direction. Thus, it is possible to curb increases in manufacturing costs and the number of manufacturing steps for the guide member 240.

### Third Preferred Embodiment

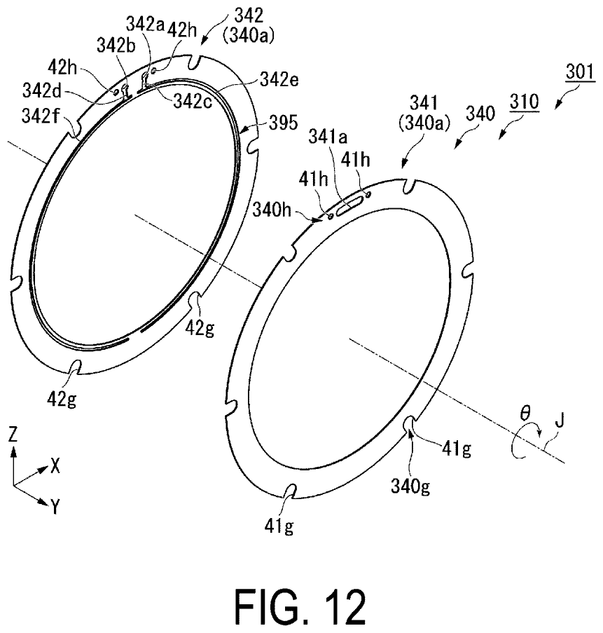

FIG. 12 is an exploded perspective view illustrating a guide member 340 of the present embodiment. In the following description, components similar to those in the first preferred embodiment described above are denoted by the same reference signs, and description thereof will be omitted.

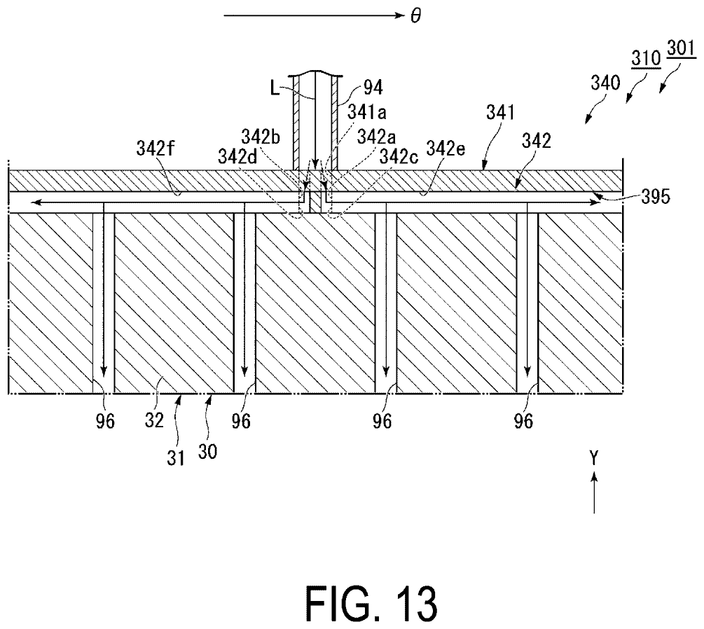

As illustrated in FIG. 13, the guide member 340 of the present embodiment includes a connection flow path portion 395 that connects a plurality of stator flow paths 96. The guide member 340 supplies a refrigerant L in the circumferential direction. As illustrated in FIG. 12, the guide member 340 includes second fastening hole portions 340g and mounting hole portions 340h. The guide member 340 is configured with a plurality of flow path members 340a stacked in the axial direction.

The second fastening hole portions 340g are holes that penetrate the guide member 340 in the axial direction. In the present embodiment, the guide member 340 includes six second fastening hole portions 340g. Each second fastening hole portion 340g is configured with fastening holes 41g and 42g. The other configurations and the like of the second fastening hole portion 340g are similar to the other configurations and the like of the second fastening hole portion 40g in the first preferred embodiment described above.

The mounting hole portions 340h are female threaded holes that penetrate the guide member 340 in the axial direction. In the present embodiment, the guide member 340 includes two mounting hole portions 340h. Each mounting hole portion 340h is configured with mounting holes 41h and 42h. The other configurations and the like of the mounting hole portion 340h are similar to the other configurations and the like of the mounting hole portion 40h in the first preferred embodiment described above.

In the present embodiment, the plurality of flow path members 340a include a first flow path member 341 and a second flow path member 342. The first flow path member 341 and the second flow path member 342 each have a plate shape that extends in a direction orthogonal to the axial direction. The first flow path member 341 and the second flow path member 342 are disposed in this order from one side in the axial direction. In the present embodiment, the first flow path member 341 and the second flow path member 342 are fixed to each other using an adhesive.

In the present embodiment, the first flow path member 341 has a substantially annular plate shape centered on the central axis J. The first flow path member 341 includes a first inflow hole 341a, a fastening hole 41g, and a mounting hole 41h. The first inflow hole 341a, the fastening hole 41g, and the mounting hole 41h each penetrate the first flow path member 341 in the axial direction.

The first inflow hole 341a is provided in a portion on the upper side (+Z side) of the first flow path member 341. In the present embodiment, the first inflow hole 341a is an elongated hole extending in the front-back direction (X-axis direction). The other configurations and the like of the first flow path member 341 are similar to the other configurations and the like of the first flow path member 41 according to the first embodiment described above.

In the present embodiment, the second flow path member 342 has a substantially annular plate shape centered on the central axis J. As illustrated in FIG. 13, the second flow path member 342 is disposed between the first flow path member 341 and the stator core 31. The surface of the second flow path member 342 which faces the other side in the axial direction is fixed to the stator core 31 using an adhesive. The second flow path member 342 is in contact with the stator core 31. As illustrated in FIG. 12, the second flow path member 342 includes two second flow path portions 342a and 342b, two first communication holes 342c and 342d, two first connection holes 342e and 342f, a fastening hole 42g, and a mounting hole 42h. The second flow path portions 342a and 342b, the first communication holes 342c and 342d, the first connection holes 342e and 342f, the fastening hole 42g, and the mounting hole 42h are holes that penetrate the second flow path member 342 in the axial direction.

The second flow path portions 342a and 342b are provided in a portion on the upper side (+Z side) of the second flow path member 342. The second flow path portions 342a and 342b are holes having a circular shape. The second flow path portions 342a and 342b may be holes that are recessed from the surface of the second flow path member 342, which faces one side in the axial direction, toward the other side in the axial direction. The second flow path portions 342a and 342b are disposed at intervals in the front-back direction (X-axis direction). The second flow path portion 342a is disposed on the front side (+X side) of the second flow path portion 342b. In the front-back direction, the second flow path portions 342a and 342b are disposed between two mounting holes 41h. When viewed in the axial direction, at least portions of the second flow path portions 342a and 342b overlap at least a portion of the first inflow hole 341a. Thereby, the second flow path portions 342a and 342b are connected to the first inflow hole 341a in the axial direction.

The first communication hole 342c is a hole that extends downward (−Z side) from the second flow path portion 342a. The first communication hole 342d is a hole that extends downward from the second flow path portion 342b. The two first connection holes 342e and 342f are holes that extend in the circumferential direction. An end of one first connection hole 342e on the other side (−θ side) in the circumferential direction is connected to the second flow path portion 342a via the first communication hole 342c. An end of the other first connection hole 342f on one side (+θ side) in the circumferential direction is connected to the second flow path portion 342b via the first communication hole 342d. That is, the two first connection holes 342e and 342f are connected to the second flow path portions 342a and 342b.

One first connection holes 342e extends from the second flow path portion 342a to one side (+θ side) in the circumferential direction. The other first connection hole 342f extends from the second flow path portion 342b to the other side (−θ side) in the circumferential direction. An end on the other side of the other first connection hole 342f in the circumferential direction and an end on one side of the one first connection hole 342e in the circumferential direction are disposed at intervals in the front-back direction (X-axis direction). As illustrated in FIG. 13, one first connection holes 342e overlaps two or more stator flow paths 96 when viewed in the axial direction. Although not shown in the drawing, in the present embodiment, one first connection hole 342e overlaps twelve stator flow paths 96 when viewed in the axial direction. The other first connection hole 342f overlaps two or more stator flow paths 96 when viewed in the axial direction. Although not shown in the drawing, in the present embodiment, the other first connection hole 342f overlaps twelve stator flow paths 96 when viewed in the axial direction. Thus, all the stator flow paths 96 overlap either one of the first connection hole 342e or the other first connection hole 342f in the axial direction. In the present embodiment, the connection flow path portion 395 is configured with the first inflow hole 341a, the second flow path portions 342a and 342b, the first communication holes 342c and 342d, and the first connection holes 342e and 342f. The connection flow path portion 395 connects a plurality of stator flow paths 96 that are disposed at different positions in the circumferential direction. The other configurations and the like of the connection flow path portion 395 are similar to the configurations and the like of the connection flow path portion 95 in the first preferred embodiment described above. The other configurations and the like of the second flow path member 342 are similar to the other configurations and the like of the second flow path member 42 in the first preferred embodiment described above. The other configurations and the like of the guide member 340 are similar to the configurations and the like of the guide member 40 in the first preferred embodiment described above. The other configurations and the like of the rotating electric machine 310 and the drive device 301 are similar to the configurations and the like of the rotating electric machine 10 and the drive device 1 in the first preferred embodiment described above.

According to the present embodiment, each of the first flow path member 341 and the second flow path member 342 has a plate shape that extends in a direction orthogonal to the axial direction. The first flow path member 341 includes the first inflow hole 341a that penetrates the first flow path member 341 in the axial direction. The second flow path member 342 includes the second flow path portions 342a and 342b connected to the first inflow hole 341a, and two first connection holes 342e and 342f. When viewed in the axial direction, at least portions of the second flow path portions 342a and 342b overlap at least a portion of the first inflow hole 341a. The two first connection holes 342e and 342f are connected to the second flow path portions 342a and 342b. One first connection hole 342e extends from the second flow path portion 342a to one side (+θ side) in the circumferential direction and overlaps two or more stator flow paths 96 when viewed in the axial direction. The other first connection hole 342f extends from the second flow path portion 342b to the other side (−θ side) in the circumferential direction and overlaps two or more stator flow paths 96 when viewed in the axial direction. Accordingly, the connection flow path portion 395 that supplies a refrigerant L to the stator flow paths 96 disposed at different positions in the circumferential direction can be configured with two flow path members 340a. Thereby, it is possible to curb an increase in the number of parts of the guide member 340. Thus, it is possible to curb increases in manufacturing costs and the number of manufacturing steps for the guide member 340.

In the present embodiment, the connection flow path portion 395 allows the refrigerant L to be supplied to the stator flow paths 96 disposed at different positions in the circumferential direction, and thus it is possible to suitably cool the stator 30 over a wide range in the circumferential direction. Thus, it is possible to curb a rise in the temperature of the entire stator 30.

In the present embodiment, the first inflow hole 341a and the two first connection holes 342e and 342f can be formed by processing the first flow path member 341 and the second flow path member 342, which have a plate shape, using a simple processing method such as press working. The connection flow path portion 395 can be configured through the simple work of stacking the first flow path member 341 and the second flow path member 342 in the axial direction. Thus, it is possible to curb increases in manufacturing costs and the number of manufacturing steps for the guide member 340.

### Fourth Preferred Embodiment

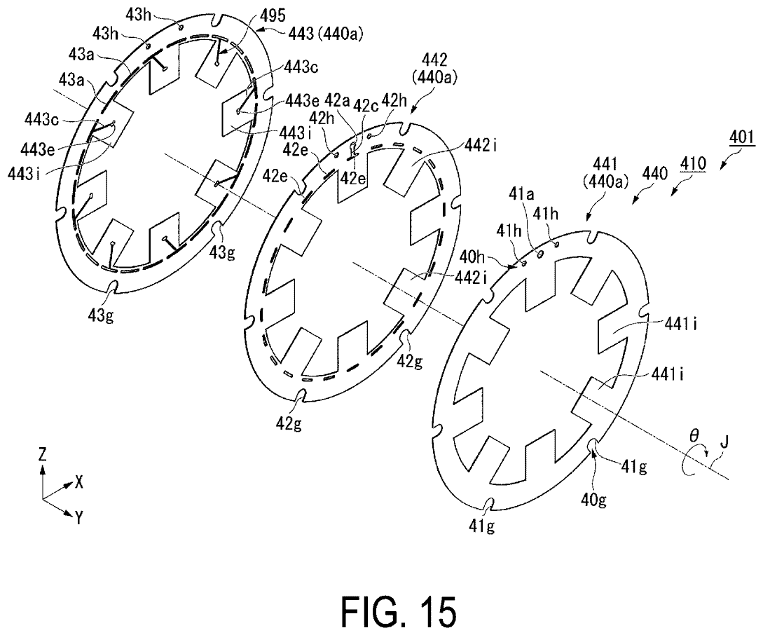

FIG. 15 is an exploded perspective view illustrating the guide member 440 of the present embodiment. In the following description, components similar to those in the first preferred embodiment described above are denoted by the same reference signs, and description thereof will be omitted.

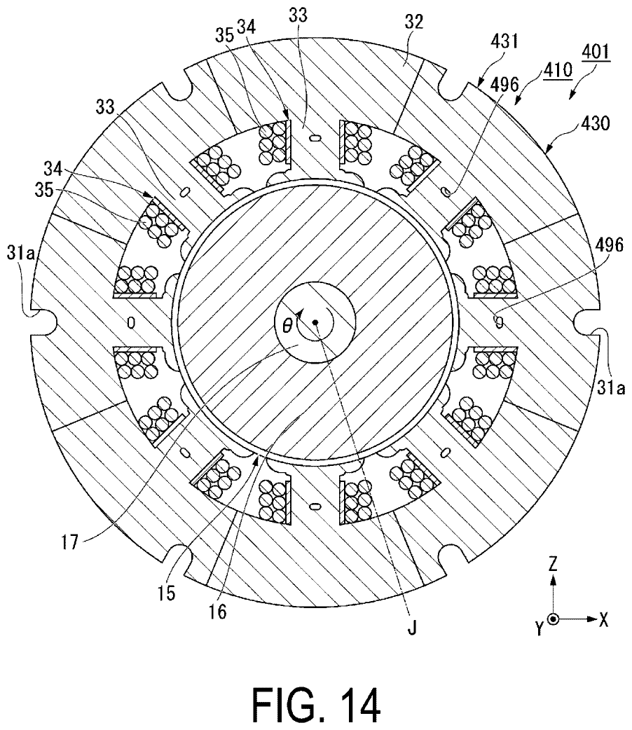

As illustrated in FIG. 14, a stator core 431 of a stator 430 of the present embodiment is provided with a plurality of stator flow paths 496. Each stator flow path 496 is a hole that penetrates the stator core 431 in the axial direction. When viewed in the axial direction, each stator flow path 496 has an elongated hole shape that extends in the circumferential direction. When viewed in the axial direction, each stator flow path 496 may have other shapes, such as a circular shape or a rectangular shape. A refrigerant L flows through each stator flow path 496. In the present embodiment, the stator core 431 is provided with eight stator flow paths 496. The number of stator flow paths 496 provided in the stator core 431 may be seven or less or may be nine or more. The stator flow paths 496 are disposed at intervals in the circumferential direction. That is, the plurality of stator flow paths 496 are disposed at different positions in the circumferential direction. In the present embodiment, the plurality of stator flow paths 496 are provided in a plurality of teeth 33.

As illustrated in FIG. 15, the guide member 440 in the present embodiment includes a connection flow path portion 495 that connects the plurality of stator flow paths 496. The guide member 440 supplies the refrigerant L in the circumferential direction. The guide member 440 is configured with a plurality of flow path members 440a stacked in the axial direction. In the present embodiment, the plurality of flow path members 440a include a first flow path member 441, a second flow path member 442, and a third flow path member 443. The first flow path member 441, the second flow path member 442, and the third flow path member 443 are disposed in this order from one side in the axial direction. The first flow path member 441, the second flow path member 442, and the third flow path member 443 are fixed to each other using an adhesive.

In the present embodiment, the first flow path member 441 is provided with a plurality of protrusions 441i. The protrusions 441i protrude inward in the radial direction from the first flow path member 441. The first flow path member 441 is provided with eight protrusions 441i. The protrusions 441i are disposed at substantially equal intervals in the circumferential direction. Although not shown in the drawing, when viewed in the axial direction, the protrusions 441i overlap different teeth 33 and different stator flow paths 496. The other configurations and the like of the first flow path member 441 are similar to the other configurations and the like of the first flow path member 41 in the first preferred embodiment described above.

In the present embodiment, the second flow path member 442 is provided with a plurality of protrusions 442i. The protrusions 442i protrude inward in the radial direction from the second flow path member 442. The second flow path member 442 is provided with eight protrusions 442i. The protrusions 442i are disposed at substantially equal intervals in the circumferential direction. Although not shown in the drawing, when viewed in the axial direction, the protrusions 442i overlap different teeth 33 and different stator flow paths 496. The other configurations and the like of the second flow path member 442 are similar to the other configurations and the like of the second flow path member 42 in the first preferred embodiment described above.

In the present embodiment, the third flow path member 443 includes a plurality of third connection holes 443c and a plurality of outflow holes 443e. The third flow path member 443 is provided with a plurality of protrusions 443i. The plurality of third connection holes 443c and the plurality of outflow holes 443e are holes that penetrate the third flow path member 443 in the axial direction.

The protrusions 443i protrude inward in the radial direction from the third flow path member 443. The third flow path member 443 is provided with eight protrusions 443i. The protrusions 443i are disposed at substantially equal intervals in the circumferential direction. Although not shown in the drawing, when viewed in the axial direction, the protrusions 443i overlap different teeth 33 and different stator flow paths 496.

Each of the plurality of third connection holes 443c is a hole that extends in the radial direction. In the present embodiment, the third flow path member 443 includes eight third connection holes 443c. The third connection holes 443c are disposed at intervals in the circumferential direction. Ends of the third connection holes 443c on the outer side in the radial direction are connected to different second connection holes 43a. Ends of the third connection holes 443c on the inner side in the radial direction reach different protrusions 443i.

Each of the plurality of outflow holes 443e is an elongated hole that extends in the circumferential direction. In the present embodiment, the third flow path member 443 includes eight outflow holes 443e. The outflow holes 443e are disposed at substantially equal intervals in the circumferential direction. The outflow holes 443e are provided in different protrusions 443i. Although not shown in the drawing, when viewed in the axial direction, the outflow holes 443e overlap different stator flow paths 496. That is, when viewed in the axial direction, the stator flow paths 496 overlap different outflow holes 443e. In the present embodiment, the connection flow path portion 495 is configured with a first inflow hole 41a, a second flow path portion 42a, a first communication hole 42c, a plurality of first connection holes 42e, a plurality of second connection holes 43a, a plurality of third connection holes 443c, and a plurality of outflow holes 443e. The connection flow path portion 495 connects a plurality of stator flow paths 496 disposed at different positions in the circumferential direction. The other configurations and the like of the third flow path member 443 are similar to the other configurations and the like of the third flow path member 43 in the first preferred embodiment described above. The other configurations and the like of the guide member 440 are similar to the configurations of the guide member 40 in the first preferred embodiment described above. The other configurations and the like of the rotating electric machine 410 and the drive device 401 are similar to the other configurations and the like of the rotating electric machine 10 and the drive device 1 in the first preferred embodiment described above.

According to the present embodiment, a plurality of stator flow paths 496 are provided for the plurality of teeth 33, respectively. As described above, a coil portion 35 is attached to each of the teeth 33. When a current is supplied to each coil portion 35, heat is generated in each coil portion 35. On the other hand, in the present embodiment, each stator flow path 496 can be disposed close to each coil portion 35, and thus it is possible to reduce thermal resistance between each coil portion 35 and the stator flow path 496. Thereby, it is possible to increase the amount of heat transferred from each coil portion 35 to the refrigerant L flowing through the stator flow path 496. Thus, it is possible to curb a rise in the temperature of the entire stator 430.

The present disclosure is not limited to the embodiments described above, and other configurations and other methods can be adopted within the scope of the technical idea of the present disclosure. The shape and configuration of the connection flow path portion are not limited to those in the present embodiment, and other shapes and configurations may be used as long as a refrigerant can be supplied to a plurality of stator flow paths disposed at different positions in the circumferential direction. The number of flow path members configuring the guide member may be five or more.

The configuration of the refrigerant flow path is not limited to that in the present embodiment, and any configuration may be adopted as long as the stator can be cooled by the refrigerant circulating within the drive device.

The rotating electric machine to which the present disclosure is applied is not limited to a motor, but may also be a generator. The application of the rotating electric machine is not particularly limited. The rotating electric machine may be mounted on equipment other than a vehicle. The application of the drive device to which the present disclosure is applied is not particularly limited. For example, the drive device may be mounted on a vehicle for an application other than an application for rotating an axle, or may be mounted on equipment other than a vehicle. The posture of the rotating electric machine and drive device when they are used is not particularly limited. The central axis may be inclined with respect to the horizontal direction orthogonal to the vertical direction, or may extend in the vertical direction.

While the embodiments of the present disclosure have been described above, the configurations in the embodiments, combinations thereof, and the like are an example, and additions, omissions, substitutions, and other modifications of the configurations can be made without departing from the spirit of the present disclosure. The present disclosure is not limited to the embodiments.

The present technique may have the following configurations.

(1)

A rotating electric machine including a rotor that is rotatable about a central axis, a stator that includes a stator core facing the rotor in a radial direction with a gap therebetween, and a guide member that is disposed on one side of the stator core in an axial direction and supplies a refrigerant in a circumferential direction, in which the stator core is provided with a plurality of stator flow paths that penetrate the stator core in the axial direction and through which the refrigerant flows, the plurality of stator flow paths are disposed at different positions in the circumferential direction, and the guide member includes a connection flow path portion that connects the plurality of stator flow paths, and is configured with a plurality of flow path members stacked in the axial direction.

(2)

The rotating electric machine according to (1), in which the guide member is in contact with the stator core in the axial direction.

(3)

The rotating electric machine according to (2), in which the plurality of flow path members include a first flow path member, a second flow path member, and a third flow path member, each of the first flow path member, the second flow path member, and the third flow path member has a plate shape that extends in a direction orthogonal to the axial direction, the second flow path member is disposed on the other side of the first flow path member in the axial direction, the third flow path member is disposed between the second flow path member and the stator core, the first flow path member includes a first inflow hole penetrating the first flow path member in the axial direction, the second flow path member includes a second flow path portion connected to the first inflow hole, and a plurality of first connection holes, the third flow path member includes a plurality of second connection holes penetrating the third flow path member in the axial direction, at least a portion of the second flow path portion overlaps at least a portion of the first inflow hole when viewed in the axial direction, the plurality of first connection holes are disposed at intervals in the circumferential direction, at least one of the first connection holes is connected to the second flow path portion, the plurality of second connection holes are disposed at intervals in the circumferential direction and overlap the first connection holes when viewed in the axial direction, and each of the plurality of stator flow paths overlaps the second connection hole when viewed in the axial direction.

(4)

The rotating electric machine according to (3), in which the plurality of flow path members include a fourth flow path member having a plate shape that extends in a direction orthogonal to the axial direction, the fourth flow path member is disposed between the third flow path member and the stator core, the fourth flow path member includes a plurality of outflow holes penetrating the fourth flow path member in the axial direction, and the plurality of outflow holes are disposed at intervals in the circumferential direction and overlap the second connection holes and the stator flow paths when viewed in the axial direction.

(5)

The rotating electric machine according to (2), in which the plurality of flow path members include a first flow path member and a second flow path member, each of the first flow path member and the second flow path member has a plate shape that extends in a direction orthogonal to the axial direction, the second flow path member is disposed between the first flow path member and the stator core, the first flow path member includes a first inflow hole that penetrates the first flow path member in the axial direction, the second flow path member includes a second flow path portion connected to the first inflow hole, and two first connection holes, at least a portion of the second flow path portion overlaps at least a portion of the first inflow hole when viewed in the axial direction, each of the two first connection holes is connected to the second flow path portion, one of the first connection holes extends to one side from the second flow path portion in the circumferential direction and overlaps two or more of the stator flow paths when viewed in the axial direction, and the other of the first connection holes extends to the other side from the second flow path portion in the circumferential direction and overlaps two or more of the stator flow paths when viewed in the axial direction.

(6)

The rotating electric machine according to any one of (3) to (5), in which a distance in the radial direction between the stator flow path and the central axis is shorter than a distance in the radial direction between the first inflow hole and the central axis.

(7)

The rotating electric machine according to any one of (3) to (6), in which the central axis extends in a direction intersecting the vertical direction, and the first inflow hole is disposed above the plurality of first connection holes in the vertical direction.

(8)

The rotating electric machine according to any one of (1) to (7), in which the stator core includes a core back portion having an annular shape and a plurality of teeth protruding from the core back portion in the radial direction, and the plurality of stator flow paths are provided in the core back portion.

(9)

The rotating electric machine according to any one of (1) to (7), in which the stator core includes a core back portion having an annular shape and a plurality of teeth protruding from the core back portion in the radial direction, and the plurality of stator flow paths are provided in the plurality of teeth, respectively.

(10)

The rotating electric machine according to (8) or (9), in which the stator includes coil portions attached to the teeth, and the guide member faces the coil portion in the radial direction.

(11)

The rotating electric machine according to (10) further includes a supply flow path portion that is connected to the connection flow path portion and supplies the refrigerant to the connection flow path portion, in which the supply flow path portion faces the coil portion in the radial direction.

(12)

The rotating electric machine according to any one of (1) to (11) further includes a housing that accommodates the rotor, the stator, and the guide member, in which the stator core includes a first fastening hole portion that penetrates the stator core in the axial direction, the guide member includes a second fastening hole portion that penetrates the guide member in the axial direction, the second fastening hole portion overlaps the first fastening hole portion when viewed in the axial direction, and the stator core and the guide member are fixed to the housing by a fastening member that passes through each of the first fastening hole portion and the second fastening hole portion in the axial direction and is fastened to the housing.

(13)

A drive device including the rotating electric machine according to any one of (1) to (12) and a gear mechanism that is connected to the rotor.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A rotating electric machine comprising:
a rotor that is rotatable about a central axis;
a stator that includes a stator core facing the rotor in a radial direction with a gap therebetween; and
a guide member that is disposed on one side of the stator core in an axial direction and supplies a refrigerant in a circumferential direction, wherein
the stator core is provided with a plurality of stator flow paths that penetrate the stator core in the axial direction and through which the refrigerant flows,
the plurality of stator flow paths are disposed at different positions in the circumferential direction, and
the guide member includes a connection flow path portion that connects the plurality of stator flow paths, and is configured with a plurality of flow path members stacked in the axial direction.

2. The rotating electric machine according to claim 1, wherein
the guide member is in contact with the stator core in the axial direction.

3. The rotating electric machine according to claim 2, wherein
the plurality of flow path members include a first flow path member, a second flow path member, and a third flow path member,
each of the first flow path member, the second flow path member, and the third flow path member has a plate shape that extends in a direction orthogonal to the axial direction,
the second flow path member is disposed on the other side of the first flow path member in the axial direction,
the third flow path member is disposed between the second flow path member and the stator core,
the first flow path member includes a first inflow hole penetrating the first flow path member in the axial direction,
the second flow path member includes a second flow path portion connected to the first inflow hole, and a plurality of first connection holes,
the third flow path member includes a plurality of second connection holes penetrating the third flow path member in the axial direction,
at least a portion of the second flow path portion overlaps at least a portion of the first inflow hole when viewed in the axial direction,
the plurality of first connection holes are disposed at intervals in the circumferential direction,
at least one of the first connection holes is connected to the second flow path portion,
the plurality of second connection holes are disposed at intervals in the circumferential direction and overlap the first connection holes when viewed in the axial direction, and
each of the plurality of stator flow paths overlaps the second connection hole when viewed in the axial direction.

4. The rotating electric machine according to claim 3, wherein
the plurality of flow path members include a fourth flow path member having a plate shape that extends in a direction orthogonal to the axial direction,
the fourth flow path member is disposed between the third flow path member and the stator core,
the fourth flow path member includes a plurality of outflow holes penetrating the fourth flow path member in the axial direction, and
the plurality of outflow holes are disposed at intervals in the circumferential direction and overlap the second connection holes and the stator flow paths when viewed in the axial direction.

5. The rotating electric machine according to claim 2, wherein
the plurality of flow path members include a first flow path member and a second flow path member,
each of the first flow path member and the second flow path member has a plate shape that extends in a direction orthogonal to the axial direction,
the second flow path member is disposed between the first flow path member and the stator core,
the first flow path member includes a first inflow hole that penetrates the first flow path member in the axial direction,
the second flow path member includes a second flow path portion connected to the first inflow hole, and two first connection holes,
at least a portion of the second flow path portion overlaps at least a portion of the first inflow hole when viewed in the axial direction,
each of the two first connection holes is connected to the second flow path portion,
one of the first connection holes extends to one side from the second flow path portion in the circumferential direction and overlaps two or more of the stator flow paths when viewed in the axial direction, and
the other of the first connection holes extends to the other side from the second flow path portion in the circumferential direction and overlaps two or more of the stator flow paths when viewed in the axial direction.

6. The rotating electric machine according to claim 3, wherein
a distance in the radial direction between the stator flow path and the central axis is shorter than a distance in the radial direction between the first inflow hole and the central axis.

7. The rotating electric machine according to claim 3, wherein
the central axis extends in a direction intersecting a vertical direction, and
the first inflow hole is disposed above the plurality of first connection holes in the vertical direction.

8. The rotating electric machine according to claim 1, wherein
the stator core includes a core back portion having an annular shape and a plurality of teeth protruding from the core back portion in the radial direction, and
the plurality of stator flow paths are provided in the core back portion.

9. The rotating electric machine according to claim 1, wherein
the stator core includes a core back portion having an annular shape and a plurality of teeth protruding from the core back portion in the radial direction, and
the plurality of stator flow paths are provided in the plurality of teeth, respectively.

10. The rotating electric machine according to claim 8, wherein
the stator includes coil portions attached to the teeth, and
the guide member faces the coil portion in the radial direction.

11. The rotating electric machine according to claim 10, further comprising a supply flow path portion that is connected to the connection flow path portion and supplies the refrigerant to the connection flow path portion, wherein
the supply flow path portion faces the coil portion in the radial direction.

12. The rotating electric machine according to claim 1, further comprising a housing that accommodates the rotor, the stator, and the guide member, wherein
the stator core includes a first fastening hole portion that penetrates the stator core in the axial direction,
the guide member includes a second fastening hole portion that penetrates the guide member in the axial direction,
the second fastening hole portion overlaps the first fastening hole portion when viewed in the axial direction, and
the stator core and the guide member are fixed to the housing by a fastening member that passes through each of the first fastening hole portion and the second fastening hole portion in the axial direction and is fastened to the housing.

13. A drive device comprising:
the rotating electric machine according to claim 1; and
a gear mechanism that is connected to the rotor.
